(19) United States
(12) Patent Application Publication
(10) Pub. No.: US 2013/0006723 A1
(43) Pub. Date: Jan. 3, 2013

(54) TOLLED ROADWAY AND METHOD FOR OPERATING A ROADWAY TOLLING SYSTEM

(76) Inventor: Thomas B. McGowan, III, Bay Village, OH (US)

(21) Appl. No.: 13/171,976

(22) Filed: Jun. 29, 2011

(51) Int. Cl. G07B 15/02

(52) U.S. Cl. 705/13

(57) ABSTRACT

A method for operating a roadway tolling system includes recording an entry time onto a ticket when a vehicle enters a tolled roadway at an entry point of an entrance location. The method also includes dispensing the ticket to an occupant of the vehicle at the entry point and collecting the ticket from the occupant when the vehicle exits the tolled roadway at an exit point of a tolling location. The method further includes recording an exit time for the vehicle at the exit point, calculating a toll for the vehicle, and calculating an average speed for the vehicle. The method further includes comparing the average speed to a speed limit, and issuing a fine to the occupant of the vehicle if the average speed of the vehicle is greater than the speed limit. A tolled roadway is also provided.

### TECHNICAL FIELD

A roadway tolling system includes an entry location and a tolling location. A ticket is dispensed to a vehicle at the entry location and collected at the tolling location.

### BACKGROUND

A tolled roadway includes a plurality of entry locations and a plurality of tolling locations. A toll booth is provided at each entry location and tolling location. When a vehicle arrives at one of the entry locations, a ticket is dispensed to the vehicle from the toll booth. Once the vehicle has completed travel on the tolled roadway and arrives at one of the tolling locations, the ticket is surrendered and a toll is calculated from the ticket. Once the toll is paid, the vehicle is permitted to leave the tolled roadway.

### SUMMARY

In accordance with one embodiment, a method for operating a roadway tolling system comprises recording an entry time onto a ticket when a vehicle enters a tolled roadway at an entry point of an entrance location. The method also comprises dispensing the ticket to an occupant of the vehicle at the entry point and collecting the ticket from the occupant when the vehicle exits the tolled roadway at an exit point of a tolling location. The method further comprises recording an exit time for the vehicle at the exit point, calculating a toll for the vehicle, and calculating an average speed for the vehicle based at least in part upon the entry time and the exit time. The method further comprises comparing the average speed for the vehicle to a speed limit for the tolled roadway between the entrance location and the tolling location, and issuing a fine to the occupant of the vehicle if the average speed of the vehicle is greater than the speed limit.

In accordance with yet another embodiment, a tolled roadway comprises an entrance location and a tolling location. The entrance location comprises at least one entry point. The at least one entry point comprises a ticket and a ticket dispenser. The ticket comprises a recorded entry time. The ticket dispenser is configured to dispense the ticket to an occupant when a vehicle arrives at the entry point. The tolling location comprises at least one exit point. The at least one exit point comprises a ticket reader. The ticket reader comprises a collection device. The ticket reader is configured to receive the ticket at the collection device from an occupant a vehicle, record an exit time, calculate a toll, calculate an average speed for a vehicle based at least in part upon the entry time and the exit time, compare the average speed to a speed limit for the tolled roadway between the entrance location and the tolling location, and issue a fine if the average speed is greater than the speed limit.

### BRIEF DESCRIPTION OF THE DRAWINGS

Various embodiments will become better understood with regard to the following description, appended claims, and accompanying drawings wherein:

FIG. 1 is a perspective view of a tolled roadway;

FIG. 2 is a perspective view of one of the entry points of FIG. 1, according to one embodiment;

FIG. 3 is a perspective view of one of the exit points of FIG. 1, according to one embodiment;

FIG. 4 is a plan view of a ticket for the tolled roadway;

FIG. 5 is a perspective view of an entry point according to another embodiment;

FIG. 6 is a perspective view of an entry point according to yet another embodiment;

FIG. 7 is a perspective view of an exit point according to another embodiment; and

FIG. 8 is a perspective view of an exit point according to yet another embodiment.

### DETAILED DESCRIPTION

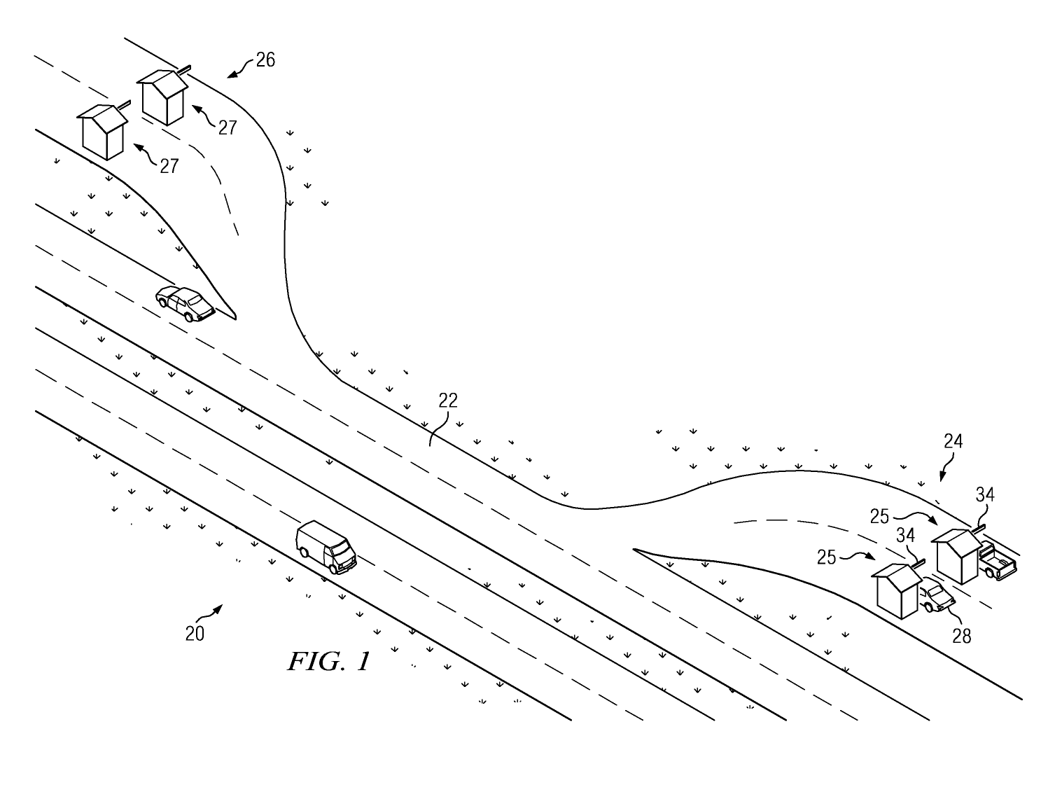

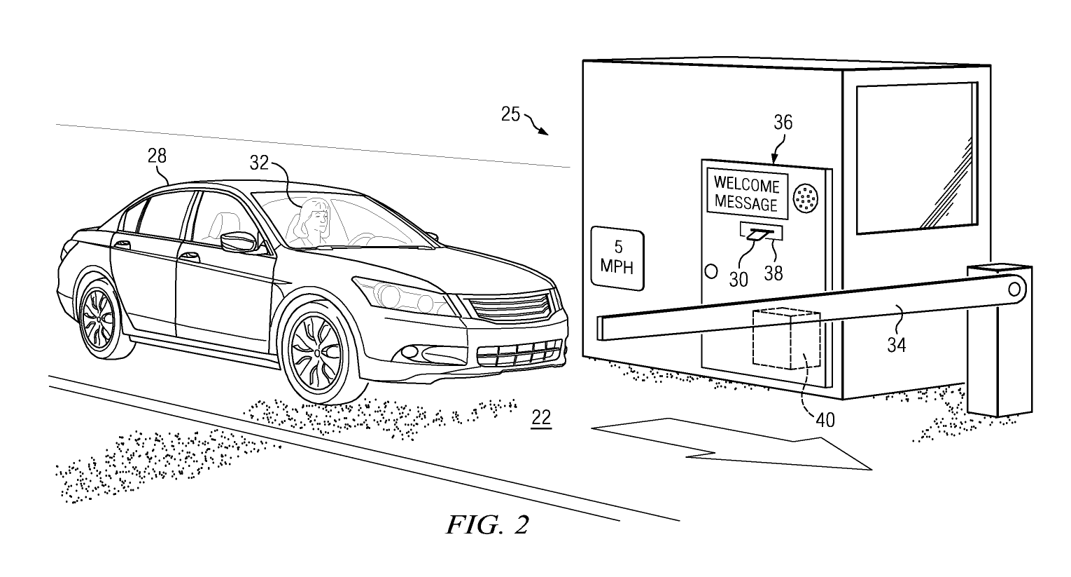

In connection with the views and examples of FIGS. 1-8, wherein like numbers indicate the same or corresponding elements throughout the views, FIG. 1 illustrates a roadway tolling system 20. The roadway tolling system 20 can include a tolled roadway 22 that includes an entrance location 24 and a tolling location 26. The entrance location 24 can include several entry points 25 (e.g., toll booths) and the tolling location 26 can include several exit points 27 (e.g., toll booths). A vehicle 28 can enter the tolled roadway 22 by way of one of the entry points 25 at the entrance location 24 and can exit the tolled roadway 22 by way of one of the exit points 27 at the tolling location 26. When the vehicle 28 arrives at the entry point 25, a ticket 30 can be dispensed to an occupant 32 of the vehicle 28, as illustrated in FIG. 2. When the occupant 32 takes the ticket, a gate 34 can be moved out of the path of the vehicle 28 to permit the vehicle 28 to enter the tolled roadway 22. After travelling along the tolled roadway 22, the vehicle 28 can arrive at the exit point 27. The ticket 30 can be collected from the occupant 32 of the vehicle 28 and a toll can be calculated for collection from the occupant 32. In one embodiment, the toll can be calculated according to a predetermined fee schedule which tabulates fees based at least in part upon the entry point and exit point of the vehicle 28 onto/from the tolled roadway 22. In other embodiments, however, the toll can be calculated as a function of time spent on the tolled roadway, weight, axle quantity, or vehicle size, for example.

In one example, as illustrated in FIG. 2, the entry point 25 can include an automated ticket dispenser 36. The automated ticket dispenser 36 can include a dispensing device 38 that can selectively dispense the ticket 30 to the vehicle 28. The automated ticket dispenser 36 can be associated with a vehicle presence detector (not shown), such as a roadway inductive loop, magnetometer, or a motion-detecting camera, for example, among others. When the vehicle presence detector detects the presence of the vehicle 28 at the entry point 25, the automated ticket dispenser 36 can automatically (e.g., without need for immediate human intervention) dispense a ticket 30 from the dispensing device 38 to the occupant 32 of the vehicle 28. When the occupant 32 takes the ticket 30 from the automated ticket dispenser 36, the gate 34 can be moved from the path of the vehicle 28 so that the vehicle 28 is permitted to proceed onto the tolled roadway 22.

As illustrated in FIG. 2, the automated ticket dispenser 36 can include (or be otherwise associated with) a central computing device 40 that can be configured to facilitate performance of certain automated features of the entry point 25. For example, the central computing device 40 can be in communication with the dispensing device 38, the vehicle presence detector (not shown), and the gate 34. The computing device 40 can be configured to cause the ticket 30 to be dispensed from the dispensing device 38 when the vehicle 28 is detected by the vehicle presence detector and to open the gate 34 when the ticket 30 is removed from the dispensing device 38. The central computing device 40 can be any suitable processor-based, computing-type arrangements such as a personal computer, for example.

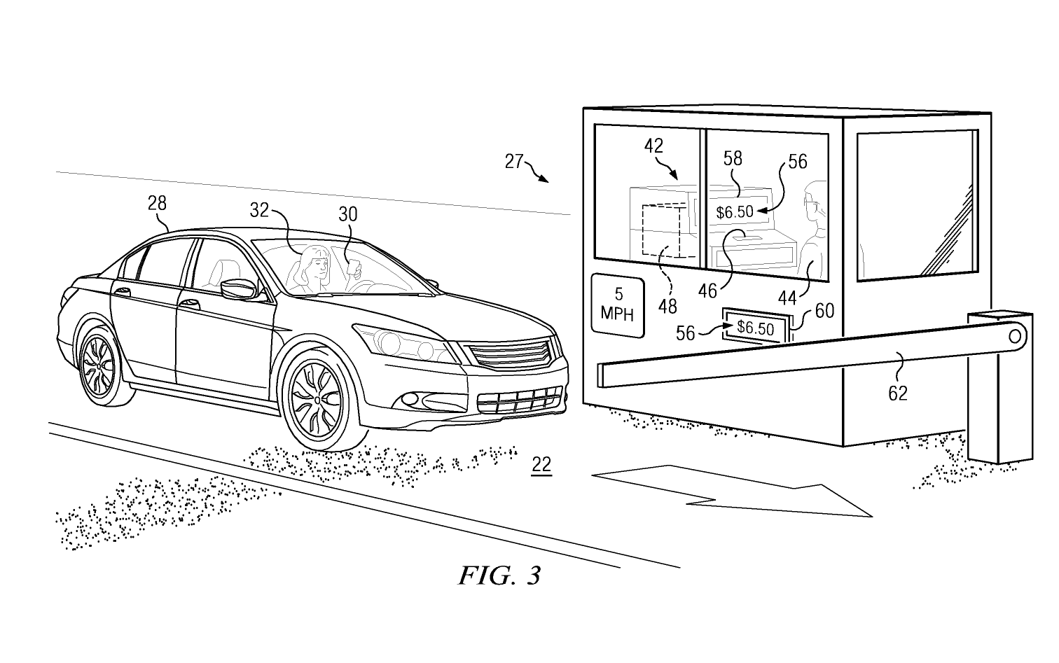

Once the vehicle 28 completes travel on the tolled roadway 22 and reaches the exit point 27, the ticket 30 can be collected from the occupant 32. In one example, as illustrated in FIG. 3, the exit point 27 can include an automated ticket reader 42 and can have a toll attendant 44 stationed at the exit point 27. The automated ticket reader 42 can include a collection device 46 for receiving the ticket 30. When the vehicle 28 arrives at the exit point 27, the toll attendant 44 can collect the ticket 30 from the occupant 32 of the vehicle 28. The toll attendant 44 can insert the ticket 30 into the collection device 46, and the automated ticket reader 42 can calculate a toll amount for the vehicle 28. As illustrated in FIG. 3, the automated ticket reader 42 can include (or be otherwise associated with) a central computing device 48 that can be similar to the central computing device 40 of the entry point 25 described above. For example, the central computing device 48 can be configured to facilitate performance of certain automated features of the exit point 27 such as operating the collection device 46 to collect the ticket 30.

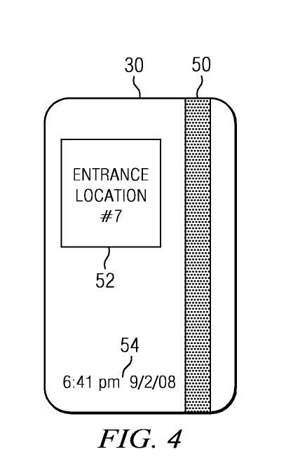

It will be appreciated that unique toll data, such as an origination location and an entry time, can be recorded onto the ticket 30. The origination location can include the name and number of the tolling location or the mile marker of the entry point 25 where the vehicle 28 entered the tolled roadway 22. The entry time can include the time of day that the vehicle 28 entered the tolled roadway 22, and in some examples, can also include the date. As illustrated in FIG. 4, the ticket 30 can have the origination location (e.g., 52) and the entry time (e.g., 54) printed on the ticket 30 such as through use of a dot matrix or ink jet printer (not shown) that can be incorporated into the automated ticket dispenser 36. As further illustrated in FIG. 4, the ticket 30 can include a programmable magnetic strip 50. The unique toll data can be stored onto the programmable magnetic strip 50. For example, when the vehicle 28 arrives at the entry point 25, the automated ticket dispenser 36 can program the unique toll data onto the programmable magnetic strip 50. When the vehicle 28 arrives at the exit point 27 and the ticket 30 is inserted into the collection device 46, the automated ticket reader 42 can read the programmable magnetic strip 50 to determine the toll amount for the vehicle 28. It will be appreciated, that unique toll data can be recorded onto a ticket in any of a variety of suitable alternative arrangements such through use of a radio frequency identification device, for example.

In one example, the automated ticket reader 42 can determine the toll amount from a toll amount look-up table that can be stored on a computer readable storage medium, such as a hard disk drive, associated with the central computing device 48. The toll amount look-up table can have different toll amounts tabulated for each entry point (e.g., 24) on the roadway tolling system 20. When the ticket 30 is inserted into the collection device 46 of the automated ticket reader 42, the automated ticket reader 42 retrieves the origination location from the programmable magnetic strip 50 and compares it to the toll amount look-up table to determine the toll amount owed by the vehicle 28.

The automated ticket reader 42 can also calculate an average speed for the vehicle 28. For example, when the vehicle 28 arrives at the exit point 27 and the ticket 30 is inserted into the collection device 46, the automated ticket reader 42 can log the current time as an exit time for the vehicle 28. The automated ticket reader 42 can subtract the exit time from the entry time retrieved from the ticket 30 to determine the travel time for the vehicle 28 between the entry point 25 and the exit point 27. The travel time can accordingly include stops along the tolled roadway 22 such as stops at rest areas, gas stations, for example, among others. The automated ticket reader 42 can then divide the distance between the entry point 25 and the exit point 27 by the travel time to determine the average speed for the vehicle 28.

In one example, the automated ticket reader 42 can determine the distance between the entry point 25 and the exit point 27 according to a roadway distance look-up table that can be stored on the computer readable storage medium associated with the central computing device 48. The roadway look-up table can include values of the roadway distances between each entry location (e.g., 24) on the tolled roadway 22 and the exit point 27. When the ticket 30 is inserted into the collection device 46 of the automated ticket reader 42, the automated ticket reader 42 can retrieve the origination location of the vehicle 28 from the programmable magnetic strip 50 and can compare it with the roadway distance look-up table to determine the distance that the vehicle 28 has travelled between the entry point 25 and the exit point 27.

The automated ticket reader 42 can compare the average speed of the vehicle 28 with a legal speed limit for the tolled roadway 22. If the average speed of the vehicle 28 exceeds the legal speed limit, the automated ticket reader 42 can issue a fine to the vehicle 28. In one example, the speed limit between the entry point 25 and the exit point 27 can be about 65 miles per hour (“M.P.H.”). If the calculated average speed of the vehicle 28 is above about 65 M.P.H., the automated ticket reader 42 can issue a fine to the vehicle 28. The fine can be a variable fine based at least in part upon the difference between the average speed of the vehicle 28 and the legal speed limit. For example, the fine could be about $5 for exceeding the legal speed limit by about 5 M.P.H. or less, about $10 for exceeding the legal speed limit by between about 6 M.P.H. and about 10 M.P.H., and about $20 for exceeding the legal speed limit by about 11 M.P.H. or more. Alternatively, however, the fine might be a flat fine that is the same amount regardless of the difference between the average speed of the vehicle 28 and the legal speed limit.

Once the toll amount and fine are calculated, an amount due 56 can be displayed to the toll attendant 44 and the occupant 32 of the vehicle 28 on respective display screens 58, 60, as illustrated in FIG. 3. If the average speed of the vehicle 28 on the tolled roadway 22 exceeded the legal speed limit, the amount due 56 can include the toll amount and the fine. However, if the average speed of the vehicle 28 on the tolled roadway 22 did not exceed the legal speed limit, the amount due 56 may only include only the toll amount. Once the toll attendant 44 collects the amount due 56 from the occupant 32, the toll attendant 44 can facilitate movement of a gate 62 from the path of the vehicle 28, with a pushbutton, for example, to permit the vehicle 28 to exit the tolled roadway 22.

It will be appreciated that the automated ticket reader 42 can calculate an average speed for the vehicle using any of a variety of suitable average speed calculations. For example, the tolled roadway 22 might have different legal speed limits between the entry point 25 and the exit point 27, such as when a portion of the tolled roadway 22 is under construction and thus maintained at a lower legal speed limit. In those instances, the legal speed limit used by the automated ticket reader 42 can be based at least in part upon all the legal speed limits for the roadway between the entry point 25 and the exit point 27. More particularly, the speed limit can be calculated by multiplying each legal speed limit between the entry point 25 and the exit point 27 by the distance associated with each speed limit, adding those results together, and dividing by the overall distance of the tolled roadway 22. For example, if the tolled roadway 22 is 10 miles long with 8 miles having a legal speed limit of 65 M.P.H. and 2 miles having a legal speed limit of 45 M.P.H., the legal speed limit used by the automated ticket reader 42 can be calculated as:

$$\frac{( ( 65 * 8 ) + ( 45 * 2 ) )}{10} = 61 M . P . H .$$

The automated ticket reader 42 can additionally or alternatively facilitate issuance of a citation to the occupant 32 of the vehicle 28 if the average speed of the vehicle 28 exceeds the legal speed limit. For example, if the average speed of the vehicle 28 exceeds the legal speed limit for the tolled roadway 22, the automated ticket reader 42 can notify an authoritative agency, such as a local police department, and can provide identifying information of the vehicle 28, such as vehicular license plate information. The authoritative agency can issue a citation which can be sent to the registered owner of the vehicle 28, through use of postal mail, email, or otherwise.

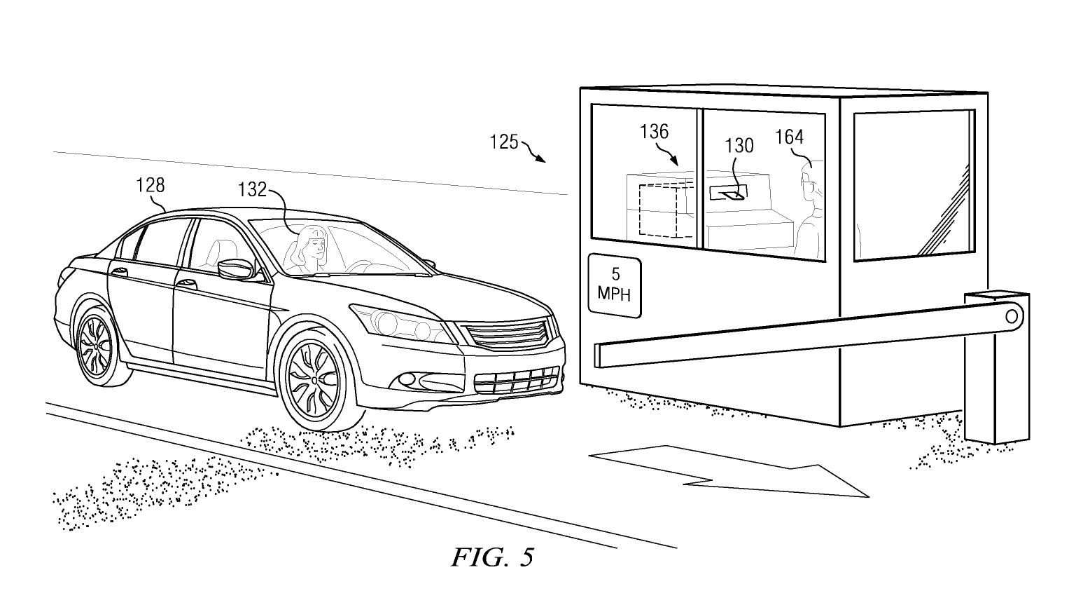

Although the entry point 25 is shown in FIG. 5 to be an automated-type entry point, it will be appreciated that an entry point can be any of a variety of suitable alternative configurations. For example, as illustrated in FIG. 5, a toll attendant 164 can be stationed at an entry point 125. The entry point 125 is similar in many respects to the entry point 25 illustrated in FIG. 2. For example, the entry point 125 includes an automated ticket dispenser 136. However, when a vehicle 128 arrives at the entry point 124, the automated ticket dispenser 136 dispenses a ticket 130 to the toll attendant 164 who then presents it to an occupant 132 of the vehicle 128.

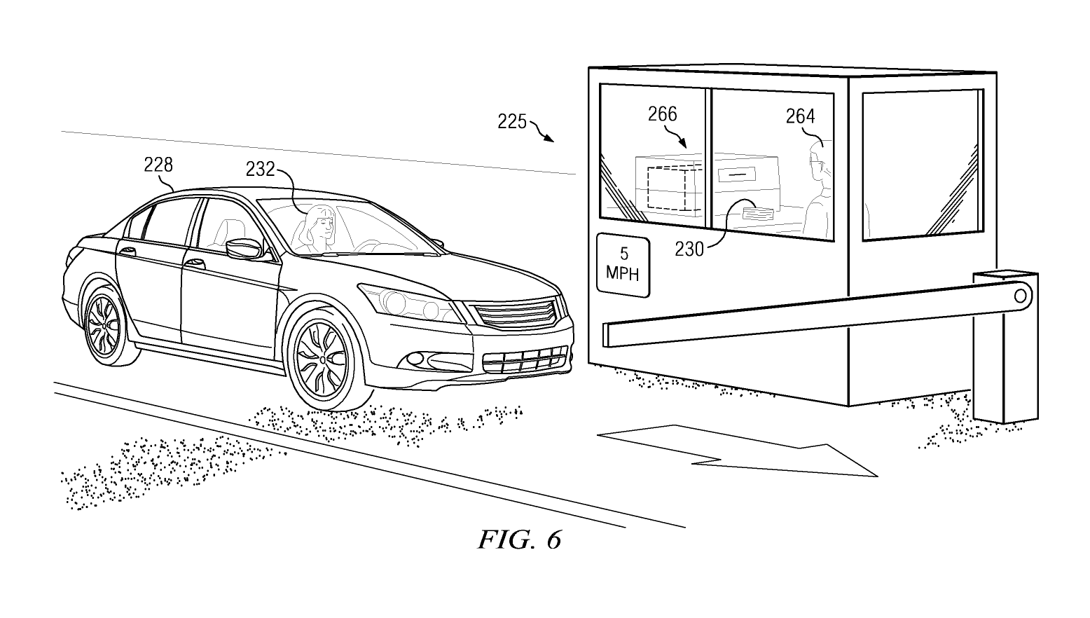

In another example, as illustrated in FIG. 6, a toll attendant 264 can be stationed at an entry point 225 in lieu of an automated ticket dispenser (e.g., 36, 136). The entry point 225 can include an electronic time stamp device 266. When a vehicle 228 arrives at the entry point 225, the toll attendant 264 can select a ticket 230 from a stack of tickets. The toll attendant 264 can place the ticket 230 into the electronic stamp device 266 to print an entry time for the vehicle 228 onto the ticket 230. The toll attendant 264 can then manually dispense the ticket 230 to an occupant 232 of the vehicle 228. The ticket 230 is shown without a programmable magnetic strip. However, it will be appreciated that a ticket for use with the electronic stamp device 266 can additionally or alternatively include a programmable magnetic strip. In such an arrangement, the electronic stamp device 266 can be configured to program the entry time to the programmable magnetic strip when the ticket is inserted into the electronic stamp device 266.

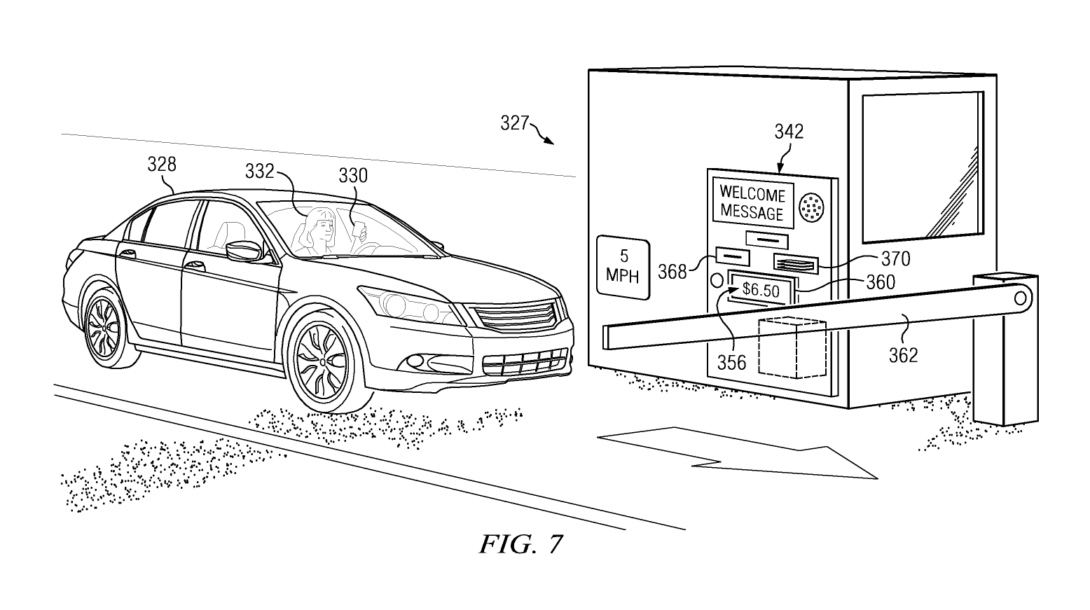

Although the exit point 27 is shown in FIG. 3 to be a manned, automated-type exit point, it will be appreciated that an exit point can be any of a variety of suitable alternative configurations. For example, as illustrated in FIG. 7, an exit point 327 can include an automated ticket reader 342 that is similar to the automated ticket reader 42 shown in FIG. 3. For example, the automated ticket reader 342 can include a collection device 346 for collecting a ticket 330. The automated ticket reader 342, however, can be arranged such that the collection device 346 can be accessible to a vehicle 328. In such an arrangement, when the vehicle 328 arrives at the exit point 327, an occupant 332 of the vehicle 328 can insert the ticket 330 into the collection device 346. The automated ticket reader 342 can calculate the toll amount and the fine for the occupant 332 and can display an amount due 356 on a display screen 360. To pay the amount due, the occupant 332 can insert currency into a currency collector 368 or can, additionally or alternatively, insert a credit card into a credit card reader 370. Once the amount due 356 has been successfully paid, the automated ticket reader 342 can automatically move a gate 362 from the path of the vehicle 328 to permit the vehicle 328 to exit the exit point 327.

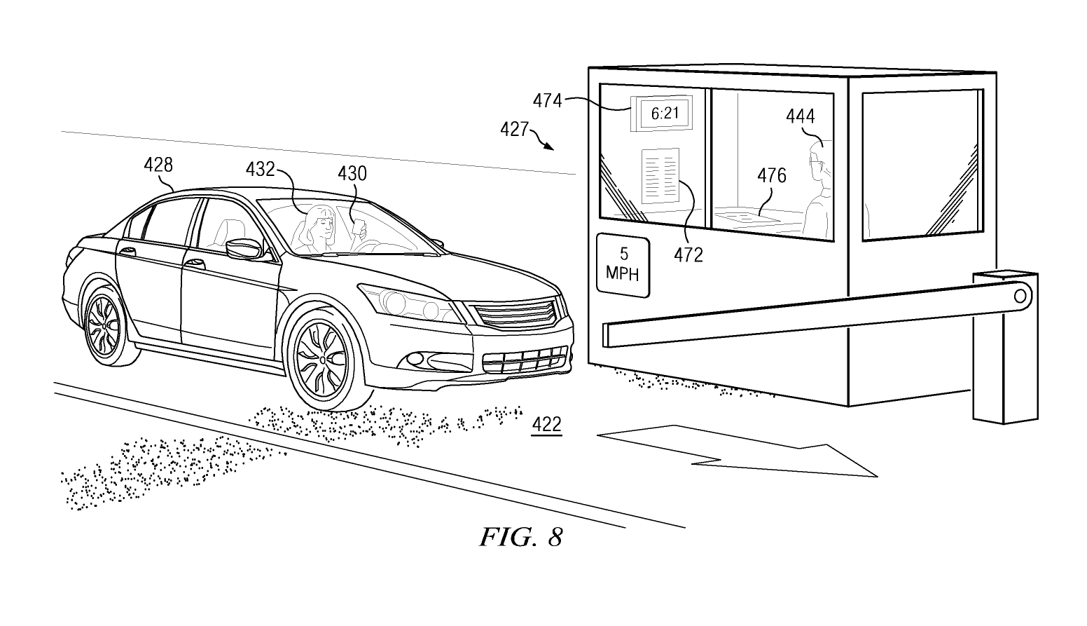

In another example, as illustrated in FIG. 8, a toll attendant 444 can be stationed at an exit point 427 in lieu of an automated ticket reader (e.g., 42, 342). When a vehicle 428 arrives at the exit point 427, the toll attendant 444 can collect a ticket 430 from an occupant 432 of the vehicle 428. The toll attendant 444 can determine a toll for the vehicle 428 by comparing an origination location 452 printed on the ticket 430 to a printed toll amount look-up table 472. The printed toll amount look-up table 472 is similar in many respects to the toll amount look-up table that is described above but instead provided in printed form. The toll attendant 444 can also compare an entry time 454 printed on the ticket 430 to a current time displayed on a clock 474 to determine a travel time for the vehicle 428. The toll attendant 444 can reference a printed roadway distance look-up table 476. The printed roadway distance look-up table 476 is similar in many respects to the roadway distance look-up table described above but instead provided in printed form. The toll attendant 444 can use the travel time and roadway distance to determine the average speed of the vehicle 428. If the average speed of the vehicle 428 is above the legal speed limit of a tolled roadway 422, the toll attendant 444 can issue a fine to the occupant 432 in addition to the toll amount. Once the toll amount and fine are collected from the occupant 432, the toll attendant 444 can facilitate opening of a gate 462 from the path of the vehicle 428 to permit the vehicle 428 to exit the tolled roadway 422. It will be appreciated that the clock 474 can be synchronized with a clock at an entry location to ensure that validity of the travel time.

The exit point 460 illustrated in FIG. 8 can alternatively be provided with an electronic ticket reader (not shown). The toll attendant 444 can insert the ticket 430 from the occupant 432 into the electronic ticket reader. The electronic ticket reader can calculate a toll and an average speed for the vehicle 428 using a toll amount look-up table and a roadway distance look-up table that is similar to the toll amount look-up table and roadway distance look-up table described above. The electronic ticket reader can be synchronized with a clock at an entry location to ensure the validity of the travel time.

A tolled roadway can include a plurality of tolling locations and entry locations. In some tolled roadway arrangements, automated ticket readers at each tolling location can be networked together, such as over a distributed network (e.g., over a Wide Area Network). The information for the automated ticket readers at each toll location, such as the toll amount look-up table and the roadway distance look-up table, can be stored at a central location and accessed by the automated ticket readers via the network. However, in an alternative tolled roadway arrangement, automated ticket readers might not be networked together except for being synchronized to a master clock. In such an arrangement, certain cost benefits may be achieved by avoiding maintenance and monitoring of networking components at each tolling location as well as maintenance and monitoring of the distributed network. It will be appreciated that the central computing device described above (e.g., 40, 48) can include hardware, software (for example, in execution), and/or firmware. For example, a component can be a process running on a processor, a processor, an object, an executable, a program, and/or a computer. Also, both an application running on a server and the server can be components. One or more components can reside within a process and a component can be localized on one computer and/or distributed between two or more computers.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented may be performed in a different order or in parallel.

What is claimed is:

1. A method for operating a roadway tolling system, the method comprising:
recording an entry time onto a ticket when a vehicle enters a tolled roadway at an entry point of an entrance location;
dispensing the ticket to an occupant of the vehicle at the entry point;
collecting the ticket from the occupant when the vehicle exits the tolled roadway at an exit point of a tolling location;
recording an exit time for the vehicle at the exit point;
calculating a toll for the vehicle;
calculating an average speed for the vehicle based at least in part upon the entry time and the exit time;
comparing the average speed for the vehicle to a speed limit for the tolled roadway between the entrance location and the tolling location; and
issuing a fine to the occupant of the vehicle if the average speed of the vehicle is greater than the speed limit.

2. The method of claim 1 further comprising collecting the toll and the fine prior to the vehicle leaving the tolling location.

3. The method of claim 1 wherein calculating an average speed for the vehicle comprises:
subtracting the entry time from the exit time to determine the travel time; and
determining a roadway distance from a roadway distance look-up table.

4. The method of claim 3 wherein determining the roadway distance comprises referencing a roadway distance look-up table that is stored on a computer readable storage medium.

5. The method of claim 1 wherein issuing the fine further comprises calculating a variable fine based at least in part upon a difference between the average speed of the vehicle and the speed limit.

6. The method of claim 5 wherein the variable fine does not exceed 20 U.S. dollars.

7. The method of claim 1 wherein:
recording the entry time onto the ticket comprises recording the entry time onto an electronic storage device of the ticket; and
recording the average speed for the vehicle comprises electronically reading the entry time from the ticket.

8. The method of claim 7 wherein the ticket comprises a programmable magnetic strip to facilitate recording of the entry time onto the electronic storage device of the ticket.

9. The method of claim 1 wherein recording the entry time onto the ticket comprises printing the entry time onto the ticket.

10. The method of claim 1 wherein the ticket comprises a paper ticket.

11. The method of claim 3 wherein calculating an average speed comprises:
calculating a travel time by subtracting the entry time from the exit time; and
dividing a driving distance travelled by the vehicle between the entry point and the tolling location by the elapsed time.

12. The method of claim 1 further comprising issuing a citation to the occupant if the average speed of the vehicle is greater than the speed limit.

13. The method of claim 1 wherein collecting the ticket from the occupant comprises collecting of the ticket by an automated ticket reader.

14. The method of claim 1 wherein collecting the ticket from the occupant comprises manually collecting of the ticket by a toll attendant at the tolling location.

15. The method of claim 1 wherein once the ticket is collected from the occupant, calculating the average speed, comparing the average speed for the vehicle to the speed limit, and issuing the fine are performed automatically.

16. The method of claim 1 wherein dispensing the ticket to the occupant comprises dispensing of the ticket by an automated ticket dispenser.

17. A tolled roadway comprising:
an entrance location comprising at least one entry point, said at least one entry point comprising:
a ticket comprising a recorded entry time; and
a ticket dispenser configured to dispense the ticket to an occupant when a vehicle arrives at the entry point; and
a tolling location comprising at least one exit point, said at least one exit point comprising a ticket reader comprising a collection device and configured to receive the ticket at the collection device from an occupant a vehicle, record an exit time, calculate a toll, calculate an average speed for a vehicle based at least in part upon the entry time and the exit time, compare the average speed to a speed limit for the tolled roadway between the entrance location and the tolling location, and issue a fine if the average speed is greater than the speed limit.
